(19) United States
(12) Patent Application Publication
(10) Pub. No.: US 2026/0140922 A1
(43) Pub. Date: May 21, 2026

(54) STORAGE SYSTEM AND METHOD OF RELOCATING DATA OF THE SAME

(71) Applicant: Samsung Electronics Co., Ltd., Suwon-si (KR)

(72) Inventors: Seungil Kim, Suwon-si (KR); Jeongwoo Park, Suwon-si (KR); Daejin Jung, Suwon-si (KR)

(21) Appl. No.: 19/386,328

(22) Filed: Nov. 12, 2025

(30) Foreign Application Priority Data
Nov. 19, 2024 (KR) 10-2024-0165200

(51) Int. Cl. G06F 16/11

(52) U.S. Cl. CPC G06F 16/119

(57) ABSTRACT

A storage system includes a storage device including a nonvolatile memory device and a host device including a file system to generate and update a file system metadata to manage data stored in the nonvolatile memory device. The file system of the host device determines a relocation of a plurality of data blocks and transfers, to the storage device, a synchronous move request including a move data descriptor indicating information on a storage location of the plurality of data blocks and a metadata descriptor indicating information on a change in the file system metadata according to the relocation. The storage device performs a data move operation to change the storage location of the plurality of data blocks based on the move data descriptor, and a metadata update operation to write a new file system metadata according to the relocation in the nonvolatile memory device based on the metadata descriptor.

### CROSS-REFERENCE TO RELATED APPLICATION

This U.S. non-provisional application claims priority under 35 USC § 119 to Korean Patent Application No. 10-2024-0165200, filed on November 19, 2024, in the Korean Intellectual Property Office (KIPO), the disclosure of which is incorporated by reference herein in its entirety.

### BACKGROUND

### 1. Technical Field

Example embodiments relate to semiconductor integrated circuits, and more particularly to a storage system and a method of relocating data of the storage system.

### 2. Discussion of the Related Art

Recently, there has been a growing need for host device-driven data relocation. Host device-driven data relocation is distinct from storage device-driven data relocation such as garbage collection. The host device includes a file system that generates and updates a system metadata (i.e., a file system metadata) to manage data stored in the nonvolatile memory device of the storage device. To improve the efficiency of data usage when file contents change, the file system may determine data relocation and may control the storage device to perform the data relocation. Such data relocation involves changes to the system metadata, and consistency between the relocated data and the system metadata has to be maintained. Consistency is also required between firmware system metadata operated by the host and nonvolatile system metadata stored in the nonvolatile memory device.

### SUMMARY

Some example embodiments may provide a storage system and a method of relocating data, capable of efficiently performing host device-driven data relocation.

According to an aspect of the present disclosure, a storage system includes a storage device including a nonvolatile memory device configured to store a plurality of data blocks associated with a file, and a host device including a file system configured to update a first file system metadata with a second file system metadata to manage the plurality of data blocks stored in the nonvolatile memory device, wherein each of the first file system metadata and the second file system metadata is a data structure representing information about the file. The host device is configured to determine, by the file system, that the plurality of data blocks stored at a plurality of first physical addresses in the nonvolatile memory device are to be moved to a plurality of second physical addresses in the nonvolatile memory device, and issue, to the storage device, a synchronous move request including a move data descriptor including a plurality of first logical addresses included in the first file system metadata and mapped to the plurality of first physical addresses of the plurality of data blocks and a plurality of second logical addresses which are to be mapped to the plurality of second physical addresses of the plurality of data blocks, and a metadata descriptor including a third logical address at which the second file system metadata is to be stored. The storage device is configured to perform, in response to the synchronous move request, a data move operation and a metadata update operation. The storage device is configured further to move, in the data move operation, the plurality of data blocks from the plurality of first physical addresses to the plurality of second physical addresses in the nonvolatile memory device based on the move data descriptor of the synchronous move request, and write, in the metadata update operation, the second file system metadata in the nonvolatile memory device. The second file system metadata includes the plurality of second logical addresses mapped to the plurality of second physical addresses. The host device is configured further to perform a file system metadata update operation to update the first file system metadata with the second file system metadata.

According to an aspect of the present disclosure, a method of performing a data relocation on a storage device driven by a host device includes determining, by a file system of the host device, a relocation of a plurality of data blocks stored in a nonvolatile memory device of the storage device, transferring, from the host device to the storage device, a synchronous move request including a move data descriptor indicating information on a storage location of the plurality of data blocks and a metadata descriptor indicating information on a change in a file system metadata according to the relocation, performing, by the storage device, a data move operation to change the storage location of the plurality of data blocks stored in the nonvolatile memory device based on the move data descriptor, and performing, by the storage device, a metadata update operation to write a new file system metadata in the nonvolatile memory device based on the metadata descriptor after the performing of the data move operation.

According to an aspect of the present disclosure, a method of performing a data relocation driven by a host device on a storage device includes determining, by a file system of the host device, a relocation of a plurality of data blocks of a file stored in a nonvolatile memory device of the storage device, transferring, from the host device to the storage device, a synchronous move request including a move data descriptor indicating information on a storage location of the plurality of data blocks and a metadata descriptor indicating information on a change in a file system metadata according to the relocation, performing, by the storage device, a data move operation to change the storage location of the plurality of data blocks stored in the nonvolatile memory device based on the move data descriptor, performing, by the storage device, a metadata update operation to write a new file system metadata in the nonvolatile memory device based on the metadata descriptor after the performing of the data move operation, transferring, from the storage device to the host device, a first response indicating success of the relocation to the host device, when the storage device completes the data move operation and the metadata update operation, and updating, by the host device, a previous file system metadata stored in the host device with the new file system metadata, when the host device receives the first response indicating success of the relocation. The previous file system metadata includes a logical address storing a first pointer indicating where the file is stored before the synchronous move request is performed and the new file system metadata includes a logical address storing a second pointer indicating where the file is to be stored after the synchronous move request is performed. The performing of the data move operation and the performing of the metadata update operation are consecutively performed in response to the synchronous move request.

The storage system and the data relocation method of the storage system according to example embodiments may perform data relocation efficiently by performing the data move operation and the metadata update operation based on a single synchronous move request, while ensuring consistency between system metadata and user data.

### BRIEF DESCRIPTION OF THE DRAWINGS

Example embodiments of the present disclosure will be more clearly understood from the following detailed description taken in conjunction with the accompanying drawings.

FIG. 1 is a block diagram illustrating a storage system according to example embodiments.

FIG. 2 is a flowchart illustrating a method of relocating data of a storage system according to example embodiments.

FIG. 3 is a diagram illustrating an example embodiment of a file system implemented in the storage system of FIG. 1.

FIG. 4 is a diagram illustrating an example structure of a system metadata generated by the file system of FIG. 3.

FIG. 5 is a sequence diagram illustrating a method of relocating data of a storage system according to example embodiments.

FIG. 6 is a diagram illustrating an example embodiment of a move data descriptor in a method of relocating data of a storage system according to example embodiments.

FIG. 7 is a diagram illustrating an example embodiment of a metadata descriptor in a method of relocating data of a storage system according to example embodiments.

FIG. 8 is a block diagram illustrating a storage controller included in a storage device according to example embodiments.

FIG. 9 is a block diagram illustrating an example embodiment of a nonvolatile memory device included in a storage device according to example embodiments.

FIG. 10 is a block diagram illustrating a storage device according to example embodiments.

FIG. 11 is a circuit diagram illustrating an equivalent circuit of a memory block included in a nonvolatile memory device included in a storage device according to example embodiments.

FIG. 12 is a diagram illustrating an example embodiment of a data move operation and a metadata update operation in a method of relocating data of a storage system according to example embodiments.

FIG. 13 is a diagram illustrating an example embodiment of a move data descriptor corresponding to the data move operation of FIG. 12.

FIG. 14 is a sequence diagram illustrating an example embodiment of operations of a storage device corresponding to the data move operation of FIG. 12.

FIGS. 15 and 16 are flowcharts illustrating example embodiments of operations of a storage device according to example embodiments.

FIG. 17 is a diagram illustrating example embodiments of response values in a method of relocating data of a storage system according to example embodiments.

FIGS. 18 and 19 are diagrams illustrating a UFS Protocol Information Unit (UPIU) used in a method of relocating data of a storage system according to example embodiments.

FIG. 20 is a diagram illustrating an example embodiment of a packet used in a method of relocating data of a storage system according to example embodiments.

FIG. 21 is a block diagram illustrating a data center including a storage system according to example embodiments.

### DETAILED DESCRIPTION OF THE EXAMPLE EMBODIMENTS

Various example embodiments will be described more fully hereinafter with reference to the accompanying drawings, in which some example embodiments are shown. In the drawings, like numerals refer to like elements throughout. The repeated descriptions may be omitted.

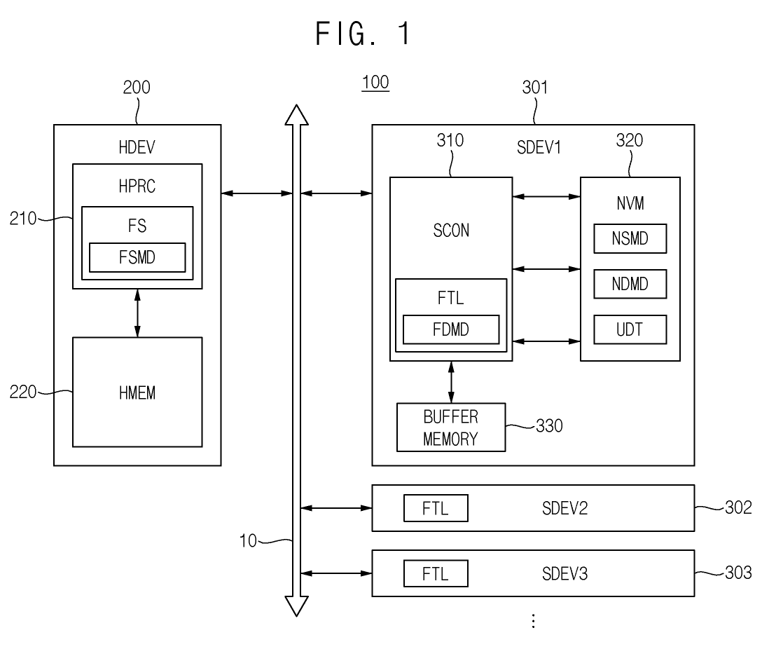

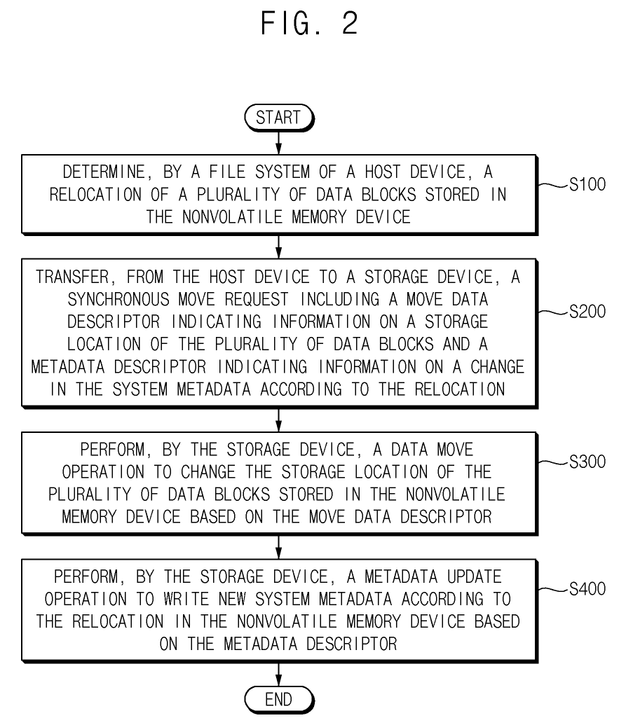

FIG. 1 is a block diagram illustrating a storage system according to example embodiments, and FIG. 2 is a flowchart illustrating a method of relocating data of a storage system according to example embodiments.

Referring to FIG. 1, a storage system 100 may include an interconnector 10, a host device (HDEV) 200, and one or more storage devices (SDEV1, SDEV2 and SDEV3) 301, 302 and 303.

The host device 200 and the storage devices 301, 302 and 303 may be connected to the interconnector 10 and may communicate signals and/or data through the interconnector 10.

The interconnector 10 may be referred to as a network fabric. The interconnector 10 may be connected to any suitable networking protocol and/or medium, such as Ethernet, Fibre Channel, and InfiniBand, either directly or through an intermediary device, such as a switch and hub, which may be a portion of the interconnector 10. The host device 200 may be implemented with any other communication or interconnect protocol that may enable communication between storage devices, such as universal flash storage (UFS), peripheral component interconnect express (PCIe), Serial ATA (SATA), Serial Attached SCSI (SAS), and OcuLink.

The host device 200 controls overall operations of the storage system 100. The host device 200 may include a host processor (HPRC) 210 and host memory (HMEM) 220.

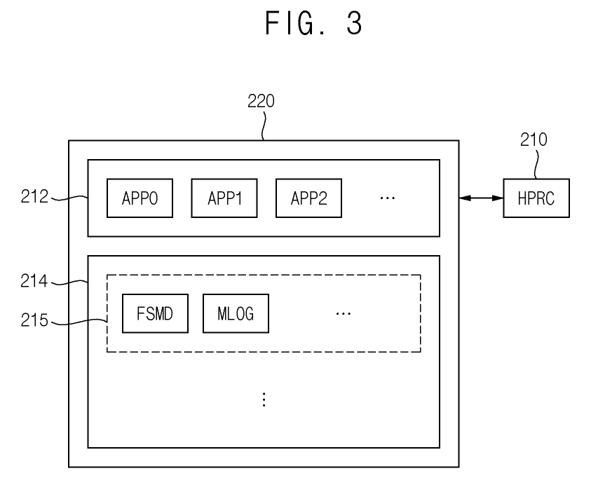

The host processor 210 executes software (applications, operating systems, device drivers, etc.). The host processor 210 may execute an operating system (OS) that is loaded into the host memory 220. The file system FS may be implemented as software executed by the host processor 210 as a portion of the operating system, as will be described below with reference to FIG. 3. The host processor 210 may also execute various applications to be run on top of the operating system. The host processor 210 may be provided as a homogeneous multi-core processor or a heterogeneous multi-core processor. A multi-core processor is a computing component having at least two independently operable processor cores (hereinafter referred to as cores). Each of the cores may independently read and execute program instructions.

The host memory 220 may store instructions to be executed and data to be processed by the host processor 210. For example, the host memory 220 may be loaded with an operating system or applications during booting stage. For example, upon booting of the storage system 100, an operating system stored in at least one of the plurality of storage devices 301, 302 and 303 may be loaded into the host memory 220, and the applications may be subsequently loaded into the host memory 220 by the operating system. Further, the host memory 220 may store a system metadata FSMD (i.e., a file system metadata) generated and managed by the file system FS. In an embodiment, the system metadata refers to data structures managed by the file system FS for maintaining information about files or directories, excluding actual file contents. The system metadata FSMD may include, but is not limited to, information such as a file name, file size, timestamps (e.g., creation, access, or modification times), access permissions, ownership information, and a logical address at which a pointer indicating where a file is stored. If the file system metadata becomes corrupted or misaligned (e.g., due to power failure such as a sudden power off (SPO)), the system may not find or properly manage the actual data blocks associated with the file - even though the data of the file may still physically exist.

While three storage devices are shown in FIG. 1 for convenience of illustration and description, example embodiments are not limited to a specific number of storage devices. In an example embodiment, the storage system may include only one storage device, and example embodiments are described herein with reference to one storage device 301. Other storage devices 302 and 303 may have the same or similar configurations as the storage device 301.

The storage device 301, which is accessed by host device 200, may include a storage controller (SCON) 310, at least one nonvolatile memory device (hereinafter may be referred to briefly as nonvolatile memory) (NVM) 320, and a buffer memory 330.

The storage controller 310 may control the operation of the storage device 301. For example, the storage controller 310 may control the operation of the nonvolatile memory device 320 based on requests (or commands) and data received from the host device 200.

The nonvolatile memory device 320 may store a variety of data. For example, the nonvolatile memory device 320 may store a system metadata NSMD, a device metadata NDMD, and user data UDT.

The system metadata NSMD may be distinct from the device metadata NDMD. For example, the kernels’s file system FS may generate or update the system metadata FSMD when a file is created, modified, or accessed. In an embodiment, the system metadata FSMD may be periodically flushed (written) to a specific location of the nonvolatile memory device 320 to ensure durability. The system metadata FSMD may be written through the flash translation layer FTL, which maps logical addresses from the file system FS to physical addresses of the nonvolatile memory device 320. The flash translation layer FTL may also its own FDMD including mapping tables, wear-level information, which is separated from the system metadata FSMD.

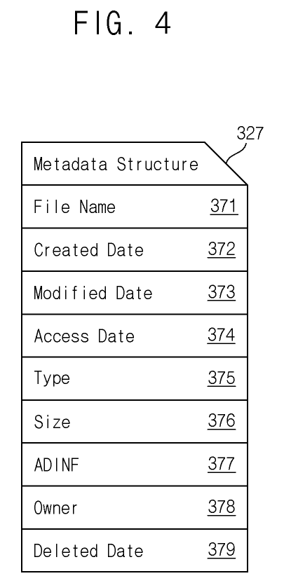

The system metadata NSMD is data that is created and updated by the file system FS to manage data stored in the nonvolatile memory device 320. The system metadata NSMD is discussed further with reference to FIG. 4.

The system metadata may be loaded from the nonvolatile memory device 320 during power-on process of the storage system 100 and stored in a volatile memory (e.g., host memory 220), such as DRAM and SRAM, of the host device 200. The system metadata stored in the nonvolatile memory device 320 may be referred to as a nonvolatile system metadata NSMD, and the system metadata stored in the host device 200 may be referred to as a firmware system metadata FSMD. The firmware system metadata FSMD may change during operation of the host device 200, and journaling techniques may be employed to maintain consistency between the firmware system metadata FSMD and the nonvolatile system metadata NSMD.

The device metadata NDMD, on the other hand, is data that the storage device 301 generates and updates by the firmware of the storage controller 310 for address translation of the nonvolatile memory device 320 or management of bad memory blocks. The device metadata NDMD may include a mapping table that represents a mapping relationship between logical addresses of the host device 1100 and physical addresses of the nonvolatile memory device 320. The mapping table may be generated and updated by the flash translation layer FTL. In addition, the flash translation layer FTL may include other information for managing memory space.

The device metadata may be loaded from the nonvolatile memory device 320 during power-on process of the storage system 100 and stored in a volatile memory (e.g., buffer memory 330) such as DRAM and SRAM in the storage controller 310. The device metadata stored in the nonvolatile memory device 320 may be referred to as a nonvolatile device metadata NDMD, and the device metadata stored in the storage controller 310 or buffer memory 330 may be referred to as a firmware device metadata FDMD. The firmware device metadata FDMD may change during operation of the storage device 301, and journaling techniques may be employed to maintain consistency between the firmware device metadata FDMD and the nonvolatile device metadata NDMD.

In an example embodiment, the nonvolatile memory device 320 may include NAND flash Memory. In other example embodiments, the nonvolatile memory device 320 may include Electrically Erasable Programmable Read-Only Memory (EEPROM), Phase Change Random Access Memory (PRAM), Resistance Random Access Memory (RRAM), Nano Floating Gate Memory (NFGM), or Polymer Random Access Memory (PoRAM), MRAM

The buffer memory 330 may temporarily store instructions and data that are to be executed or processed by the storage controller 310. The buffer memory 330 may temporarily store data that is to be written or has been read from the nonvolatile memory device 320. For example, the buffer memory 330 may include volatile memory, such as static random access memory (SRAM) and dynamic random access memory (DRAM).

In an example embodiment, the storage device 301 may be a universal flash storage (UFS), a solid state drive (SSD), a multi-media card (MMC), or an embedded MMC (eMMC). In another example embodiment, the storage device 301 may be implemented as a Secure Digital (SD) card, micro SD card, memory stick, chip card, Universal Serial Bus (USB) card, smart card, Compact Flash (CF) card, or the like.

In an example embodiment, the storage device 301 may be connected to the host device 200 via the interconnector 10, which may include a Serial Advanced Technology Attachment (SATA) bus, Small Computer Small Interface (SCSI) bus, Nonvolatile Memory Express (NVMe) bus, Serial Attached SCSI (SAS) bus, UFS, eMMC, or other bus, and may be accessed by host device 200 on a block-by-block basis via a block-accessible interface. For example, the host device 200 may access the storage device 301 as a block device. The interface between the host device 200 and the storage device 301 may be managed in block units (e.g., 512 bytes or 4KB). Although the storage device 301 is presented to the host device 200 as a block-addressable device, the storage device 301 may be internally controlled to perform a read or write operation at a page level, and an erase operation at a block level. The flash translation layer FTL may handle this mismatch between host block access and physical flash behavior.

Referring to FIGS. 1 and 2, the file system FS of the host device 200 may determine a relocation of a plurality of data blocks stored in the nonvolatile memory device 320 (S100). In an embodiment, the host device 200 may operate using an Android operating system. For example, the host device 200 may trigger maintenance processes that include defragmentation-like behavior for file system optimization or log-structured storage management. These processes are typically run automatically during idle times, charging, or overnight via scheduled tasks. Some file systems (e.g., F2FS, used in Android) may support background cleaning and segment reallocation to reduce fragmentation. The host device 200 may mount the file system with options that allow such cleaning operations. In a conventional system, a host device may issue TRIM (or UNMAP) commands to a storage device to inform it of blocks that are no longer in use. In response to the TRIM (or UNMAP) commands, a storage controller may optimize internal data placement and garbage collection (the storage-driven data relocation). The present invention discloses a synchronous move request to facilitate a host-driven data relocation during the maintenance processes.

A synchronous move request (or synchronous move command) SMREQ may be transferred or issued from the host device 200 to the storage device 301 (S200). For example, the host device 200 may issue the synchronous move request SMREQ to the storage device 301. The synchronous move request may include a move data descriptor MVDRT indicating information on storage location of the plurality of data blocks and a metadata descriptor MTDRT indicating information on changes in the system metadata according to the relocation. For example, the information on the changes in the system metadata may include an updated system metadata including a new logical address for a moved file (e.g., logical address in LBA1’ to LBA4’ in FIG. 13) and a logical address (e.g., a logical address LBAm in FIG. 7) at which the updated system metadata is to be stored after the synchronous move request is successfully performed. The metadata descriptor MTDRT will be further described with reference to FIG. 7.

A data move operation DMO may be performed by the storage device 301 to change the storage location of the plurality of data blocks stored in the nonvolatile memory device 320 based on the move data descriptor MVDRT (S300).

A metadata update operation NMUO may be performed by the storage device 301 to write a new system metadata according to the relocation in the nonvolatile memory device 320 based on the metadata descriptor MTDRT (S400).

As such, the storage device 301, the storage system 100, and the data relocation method of the storage system 100 according to example embodiments may perform the data relocation efficiently by performing the data move operation DMO and the metadata update operation NMUO based on the single synchronous move request SMREQ, while ensuring consistency between system metadata and user data.

FIG. 3 is a diagram illustrating an example embodiment of a file system implemented in the storage system of FIG. 1.

FIG. 3 illustrates an exemplary software structure of the storage system 100 of FIG. 1. Referring to FIG. 3, the software hierarchy of the storage system 100 loaded into the host memory 220 and driven by the host processor 210 may be divided into applications 212 and a kernel 214 of an operating system. The operating system may further include device drivers to manage various devices such as memory, modems, and image processing devices.

The applications (APP0, APP1 and APP2) 212 are higher-level software that may run as basic services or be triggered by user requests. The applications 212 may be running simultaneously to provide various services. The applications 212 may be executed by the host processor 210 after being loaded into the host memory 220 of FIG. 1.

The kernel 214 is a component of the operating system that performs control operations between the applications 212 and the hardware. The kernel 214 may include program execution, interrupts, multitasking, memory management, file systems, and device drivers. According to example embodiments, only the file system 215 provided as a portion of the kernel 214 will be described.

The user space, where the applications 212 resides, and the kernel space, where the kernel 214 resides, including the file system 215, input/output scheduler, or device drivers, may be separate from each other. The applications 212 may not have direct access to resources such as the storage device 301 of FIG. 1. Instead, the applications 212 may call functions defined on a library (not shown) that includes system call functions and may request the necessary operations from the kernel 214. When the system call function is called, a transition from user mode to kernel mode may occur.

The file system 215 may manage files or data (user data) stored in the storage device 301. For example, the file system 215 may include a file allocation table (FAT), new technology file system (NTFS), hierarchical file system (HFS), high performance file system (HPFS), unix file system (UFS), secondary extended file system (ext2), ext3, ext4, journaling file system (JFS), ISO 9660, Files-11, veritas file system (VxFS), ZFS, ReiserFS, or universal disk format (UDF). The file system 215 may also perform journaling to prevent databases, files, or data from becoming inconsistent due to a sudden power off (SPO) or system crash.

While the file system 215 stores data in the nonvolatile memory device 320 of the storage device 301, the file system 215 may generate a system metadata FSMD used to manage the data and store the generated metadata FSMD as a data structure in the nonvolatile memory device 320. The file system 215 may also store the system metadata FSMD in the host memory 220. The file system 215 may store changes to files, if any, in a meta log MLOG. As mentioned above, this system metadata FSMD may be distinguished from the device metadata FDMD that the storage device 301 manages for address translation of the nonvolatile memory device 320 or management of bad memory blocks.

FIG. 4 is a diagram illustrating an example structure of a system metadata generated by the file system of FIG. 3. FIG. 4 illustrates a system metadata structure corresponding to a single file.

Referring to FIG. 4, the metadata structure 327 may include various data fields.

These data fields may include a file name 371, a created date 372 when the file was created (as used herein, the term ‘date’ is intended to include both date and time), a modified date 373 when the file was last changed, an access date 374 when the file was last accessed, a type 375 for the file (e.g., executable, document, text file, or other), a size 376 of the file, address information (ADINF) 377, an owner 378 of the file, and a deletion date 379. In an embodiment, the ADINF 377 may be a field representing a logical address storing a pointer indicating where the file is stored. For example, the system metadata FSMD may include a logical address storing a first pointer indicating where the file is stored before the synchronous move request is performed, and the new system metadata FSMD’ may include a logical address storing a second pointe indicating where the file is to be stored after the synchronous move request is performed.

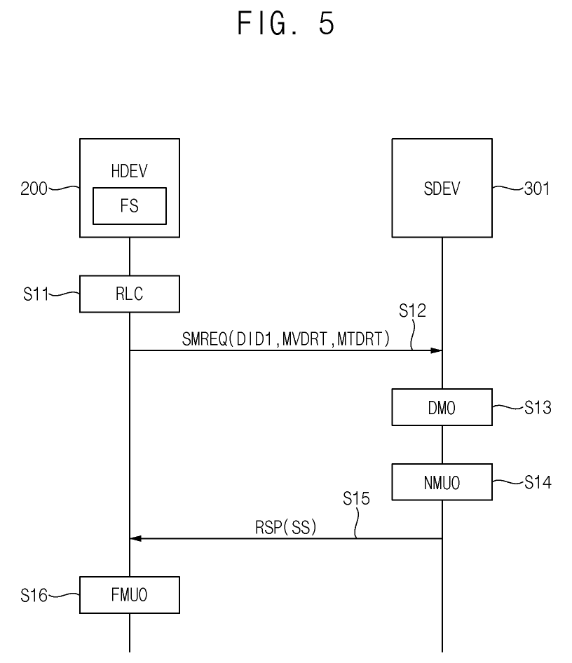

FIG. 5 is a sequence diagram illustrating a method of relocating data of a storage system according to example embodiments.

Referring to FIG. 5, a file system FS of a host device 200 may determine a relocation RLC of a plurality of data blocks stored in a nonvolatile memory device 320 of a storage device 301 (S11). In an embodiment, the relocation RLC of the plurality of data blocks may be automatically determined by an operating system of the host device 200 during idle periods of the storage system 100, or while charging or overnight through scheduled tasks.

The host device 200 may transfer or issue a synchronous move request SMREQ to the storage device 301 based on the relocation decision (S12). The synchronous move request SMREQ may include a device identifier DID1, a move data descriptor MVDRT, and a metadata descriptor MTDRT representing the storage device 301. As described above, the move data descriptor MVDRT indicates information regarding the storage location of the plurality of data blocks that are subject to the relocation, and the metadata descriptor MTDRT indicates information regarding changes in the system metadata as a result of the relocation.

The storage device 301 may perform a data move operation DMO based on the move data descriptor MVDRT (S13) and subsequently perform a metadata update operation NMUO (S14) without any further control from the host device 200. In an embodiment, the storage device 301 may perform the data move operation DMO and the metadata update operation NMUO consecutively in response to the synchronous move request SMREQ without additional intervention of the host device 200. As described above, the data move operation DMO represents an operation to change the storage location of the plurality of data blocks stored in the nonvolatile memory device 320 based on the move data descriptor MVDRT, and the metadata update operation NMUO represents an operation to write a new system metadata (i.e., a second file system metadata) according to the relocation in the nonvolatile memory device 320 based on the metadata descriptor MTDRT.

Upon completion of the data move operation DMO and the metadata update operation NMUO, the storage device 301 may transfer or issue a response RSP to the host device 200 indicating the success SS of the relocation (S15).

Upon receiving the response RSP indicating the success of the relocation SS, the host device 200 may perform a firmware metadata update operation FMUO to update the previous system metadata FSMD (i.e., a first file system metadata) stored in the host device 200 with the new system metadata FSMD' (i.e., a second file system metadata) (S16). In an embodiment, the previous system metadata FSMD may include logical addresses mapped to the data stored at a plurality of first physical addresses in the storage device 301 before the relocation, and the new system metadata FSMD’ may include a logical address for storing a pointer indicating where a file after the relocation is to be stored. For example, in the data move operation DMO, the data stored at the plurality of first physical addresses may be moved or relocated to the plurality of second physical addresses.

As such, the storage device 301 may sequentially perform the data move operation DMO and the metadata update operation NMUO in response to the single synchronous move request SMREQ. For example, the data move operation DMO and the metadata update operation NMUO may be consecutively performed without performing no intervening operation. According to the present disclosure, to perform data relocation, requests exchanged by the host device 200 and the storage device 301 may be compressed into the single synchronous move request SMREQ, thereby suppressing frequent communication between the host device 200 and the storage device 301 and improving the performance of the storage system 100.

In addition, the data relocation in response to the synchronous move request SMREQ according to the present disclosure may avoid the plurality of data blocks from being transferred between the host device 200 and the storage device 301 for the relocation. Accordingly, resources such as host memory 220 that are wasted for storage of the read data blocks may be saved and the performance of the storage system 100 may be improved. For the host device 200 to change the location of a single file stored in the storage device 301, one data read operation, one data write operation, and one metadata write operation may be required, along with an optional UNMAP without using the synchronous move request SMREQ according to the present disclosure. For example, without using the synchronous move request SMREQ according to the present disclosure, a total of 4 command transmissions, 4 data transmissions, and 4 response transmissions are necessary. Moving a single piece of data (e.g., a single file) thus results in a total of 12 message exchanges, all of which must be performed synchronously, not asynchronously, which further increases latency. However, performing of the synchronous move request SMREQ according to the present disclosure may avoid such data exchange between the host device 200 and the storage device 301. In other words, the host device 200 may move the single file to another location of the storage device 301 using the synchronous move request SMREQ, without exchanging the data associated with the file between the host device 200 and the storage device 301.

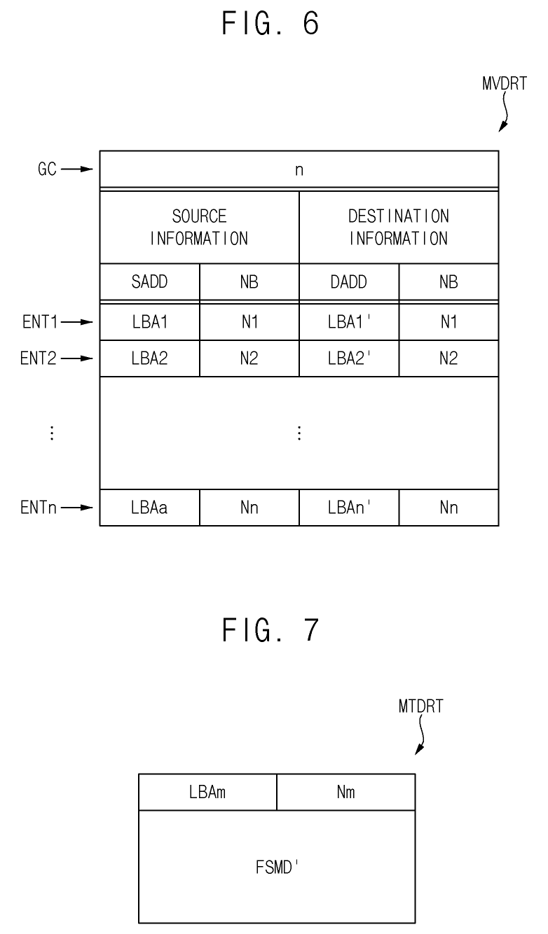

FIG. 6 is a diagram illustrating an example embodiment of a move data descriptor in a method of relocating data of a storage system according to example embodiments.

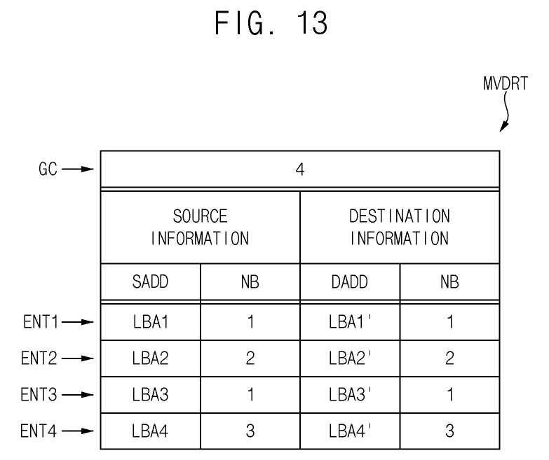

As will be described below with reference to FIG. 12, a plurality of data blocks subject to relocation may be grouped into a plurality of data groups stored and distributed in the nonvolatile memory device 320. For example, the plurality of data blocks may be scattered into the plurality of data groups, which are stored in the physical addresses which are non-contiguous. Such scattered data groups may be subject to a defragmentation operation which will be described with reference to FIG. 12.

Referring to FIG. 6, the move data descriptor MVDRT may include a group count GC and a plurality of data entries ENT1 to ENTn.

The group count GC may indicate the number of the plurality of data entries ENT1 to ENTn included in the move data descriptor MVDRT. In some example embodiments, the group count GC may be omitted and not included in the move data descriptor MVDRT.

The plurality of data entries ENT1 to ENTn may correspond to a plurality of data groups stored and distributed in the nonvolatile memory device 320, respectively.

Each data entry ENTi (i=1 to n) of the plurality of data entries ENT1 to ENTn may include source information and destination information.

The source information may include the logical address SADD before the data move operation DMO of each data group and the number of data blocks NB included in each data group. The logical address SADD may correspond to a start address of the respective data group. The flash translation layer FTL of the storage controller 310 may manage mapping between the logical address SADD of the source information and its associated physical address (i.e., a first physical address) of the storage device 301.

The destination information may include the logical address DADD after the data move operation DMO of each data group and the number of data blocks NB included in each data group. The flash translation layer FTL of the storage controller 310 may change the mapping between the logical address SADD and its associated physical address (i..e, a second physical address) using the logical address DADD of the destination information. For example, in the data relocation of FIG. 12, the logical address DADD may be mapped to the second physical address at which the relocated data is stored. In the data move operation, data stored at the first physical address may be moved to the second physical address, and the flash translation layer FTL may map the second physical address to the logical address DADD of the destination information.

FIG. 7 is a diagram illustrating an example embodiment of a metadata descriptor in a method of relocating data of a storage system according to example embodiments.

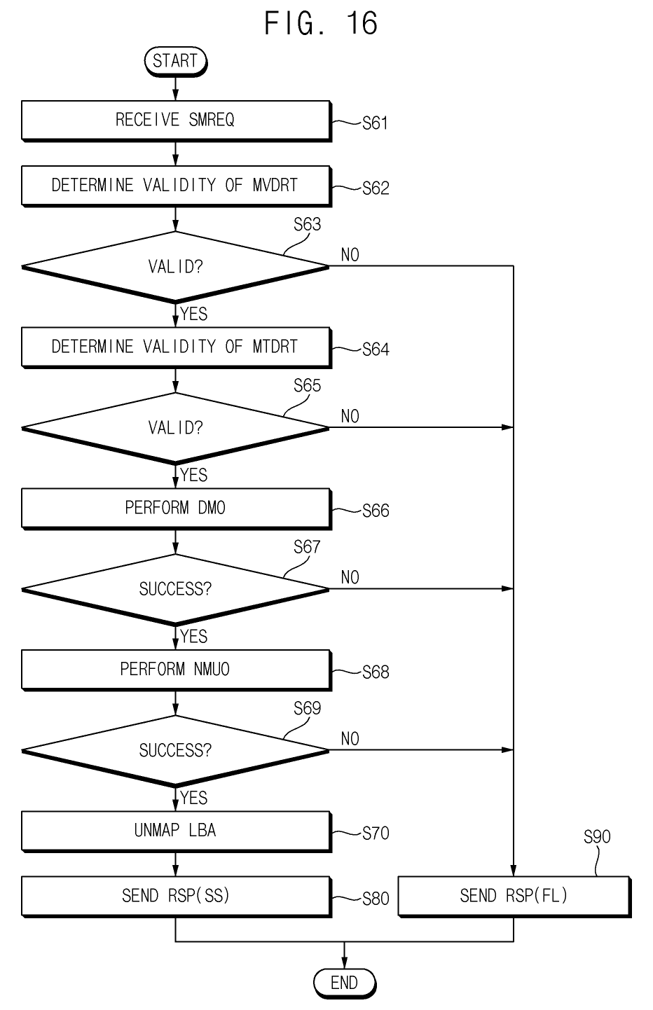

Referring to FIG. 7, the metadata descriptor MTDRT may include a new system metadata FSMD‘ resulting from the data relocation, a logical address LBAm of the new system metadata FSMD‘, and a size Nm of the new system metadata FSMD’. For example, the metadata descriptor MTDRT may include two fields including a system metadata field and a metadata information field. The system metadata field may represent a system metadata of the new system metadata FSMD’ which includes the logical addresses LBA1’ to LBAn’ of the logical address DADD of the destination information as shown in FIG. 6. The metadata information field may represent a logical address at which the new system metadata FSMD’ is to be stored. For example, the metadata information field may include a field representing the logical address LBAm at which the new system metadata FSMD’ is to be. stored and a field representing the size Nm of the new system metadata FSMD’. When issuing the synchronous move request SMREQ to the storage device 301, the host device 200 informs the storage device 301 of the logical address LBAm at which the system metadata FSMD’ (i.e., updated system metadata after data relocation) is to be stored. In an embodiment, the logical address LBAm of the metadata descriptor MTDRT may be different from a logical address at which the previous system metadata is stored. The present invention is not limited thereto. In an embodiment, the logical address LBAm of the metadata descriptor MTDRT may be the same as a logical address at which the previous system metadata is stored. In a consistency check (or integrity check), which will be described with reference to FIG. 15, the storage device 301 may check whether the metadata descriptor MTDRT received from the host device 200 conforms to this format.

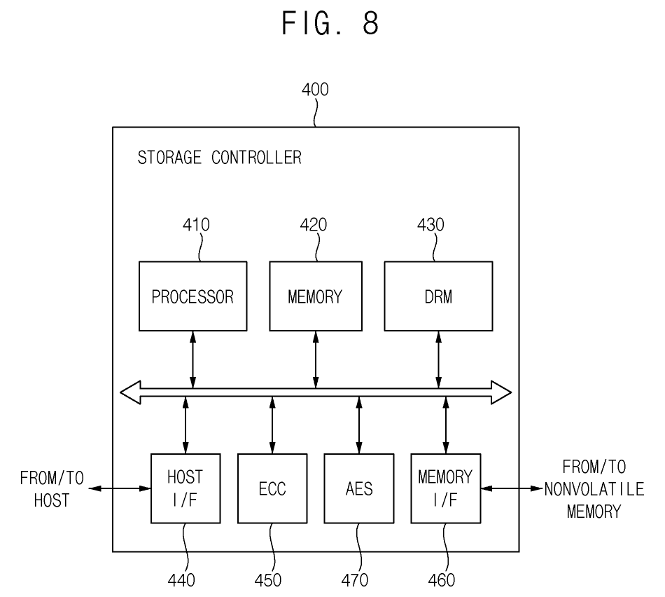

Hereinafter, with reference to FIGS. 8 to 11, a storage device implemented in flash memory will be described. Example embodiments are not limited to flash memory and may be applied to storage systems including any type of nonvolatile memory.

FIG. 8 is a block diagram illustrating a storage controller included in a storage device according to example embodiments.

Referring to FIG. 8, a storage controller 400 may include a processor 410, a memory 420, a data relocation manager DRM 430, a host interface (I/F) 440, an error correction code (ECC) engine 450, a memory interface (I/F) 460 and an advanced encryption standard (AES) engine 470.

The processor 410 may control an operation of the storage controller 400 in response to a command received via the host interface 440 from a host device (e.g., the host device 200 in FIG. 1). For example, the processor 410 may control an operation of a storage device (e.g., the first storage device 301 in FIG. 1), and may control respective components by employing firmware for operating the storage device.

The memory 420 may store instructions and data executed and processed by the processor 410. For example, the memory 420 may be implemented with a volatile memory, such as a DRAM, a SRAM, and a cache memory.

The data relocation manager 430 may control the data relocation as described above. The data relocation manager 430 may store the move data descriptor MVDRT and the metadata descriptor MTDRT transferred from the host device 200, and may control the read operation and write operation for relocating the data based on the move data descriptor MVDRT and the metadata descriptor MTDRT. The data relocation manager 430 may be implemented as software, such as program code executed by the processor 410, or as separate hardware distinct from the processor 410, or as a combination of software and hardware.

The ECC engine 450 for error correction may perform coded modulation using a Bose-Chaudhuri-Hocquenghem (BCH) code, a low density parity check (LDPC) code, a turbo code, a Reed-Solomon code, a convolution code, a recursive systematic code (RSC), a trellis-coded modulation (TCM), a block coded modulation (BCM), etc., or may perform ECC encoding and ECC decoding using above-described codes or other error correction codes.

The host interface 440 may provide physical connections between the host device and the storage device. The host interface 440 may provide an interface corresponding to a bus format of the host device for communication between the host device and the storage device. In some example embodiments, the bus format of the host device may be a small computer system interface (SCSI) or a serial attached SCSI (SAS) interface. In other example embodiments, the bus format of the host device may be a USB, a peripheral component interconnect (PCI) express (PCIe), an advanced technology attachment (ATA), a parallel ATA (PATA), an SATA, a nonvolatile memory (NVM) express (NVMe), etc., format.

The memory interface 460 may communicate data with a nonvolatile memory (e.g., the nonvolatile memory devices 320 in FIG. 1). The memory interface 460 may transfer data to the nonvolatile memory, or may receive data read from the nonvolatile memory. In some example embodiments, the memory interface 460 may be connected to the nonvolatile memory via one channel. In other example embodiments, the memory interface 460 may be connected to the nonvolatile memory via two or more channels. For example, the memory interface 460 may be configured to comply with a standard protocol, such as Toggle and open NAND flash interface (ONFI).

The AES engine 470 may perform at least one of an encryption operation and a decryption operation on data input to the storage controller 400 using a symmetric-key algorithm. The AES engine 470 may include an encryption module and a decryption module. For example, the encryption module and the decryption module may be implemented as separate modules. For another example, one module capable of performing both encryption and decryption operations may be implemented in the AES engine 470.

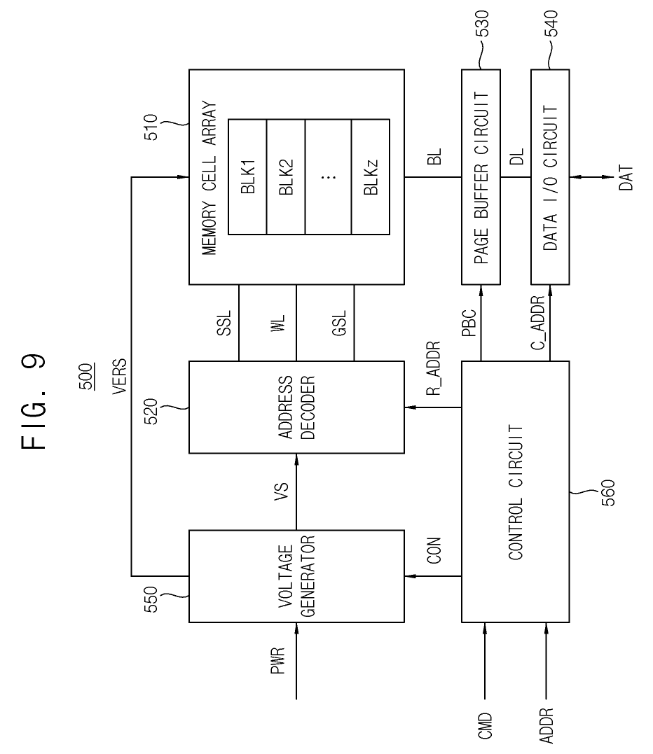

FIG. 9 is a block diagram illustrating an example embodiment of a nonvolatile memory device included in a storage device according to example embodiments.

FIG. 9 is a block diagram illustrating an example embodiment of a nonvolatile memory device included in a storage system according to example embodiments.

Referring to FIG. 9, a nonvolatile memory 500 includes a memory cell array 510, an address decoder 520, a page buffer circuit 530, a data I/O circuit 540, a voltage generator 550 and a control circuit 560.

The memory cell array 510 is connected to the address decoder 520 via a plurality of string selection lines SSL, a plurality of wordlines WL and a plurality of ground selection lines GSL. The memory cell array 510 is further connected to the page buffer circuit 530 via a plurality of bitlines BL. The memory cell array 510 may include a plurality of memory cells (e.g., a plurality of nonvolatile memory cells) that are connected to the plurality of wordlines WL and the plurality of bitlines BL. The memory cell array 510 may be divided into a plurality of memory blocks BLK1, BLK2, ..., BLKz, each of which includes memory cells. In addition, each of the plurality of memory blocks BLK1, BLK2, ..., BLKz may be divided into a plurality of pages.

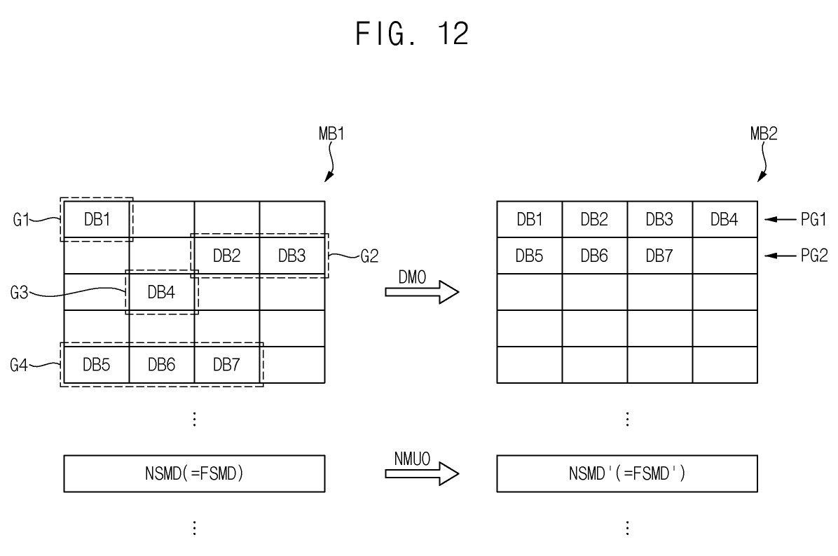

In some example embodiments, the plurality of memory cells included in the memory cell array 510 may be arranged in a two-dimensional (2D) array structure or a three-dimensional (3D) vertical array structure. The memory cell array of the 3D vertical array structure will be described below with reference to FIG. 11.

The control circuit 560 receives a command CMD and an address ADDR from an outside (e.g., from the storage controller 310 in FIG. 1), and controls erasure, programming and read operations of the nonvolatile memory 500 based on the command CMD and the address ADDR. An erasure operation may include performing a sequence of erase loops, and a program operation may include performing a sequence of program loops. Each program loop may include a program operation and a program verification operation. Each erase loop may include an erase operation and an erase verification operation. The read operation may include a normal read operation and data recover read operation.

For example, the control circuit 560 may generate control signals CON, which are used for controlling the voltage generator 550, and may generate control signal PBC for controlling the page buffer circuit 530, based on the command CMD, and may generate a row address R_ADDR and a column address C_ADDR based on the address ADDR. The control circuit 560 may provide the row address R_ADDR to the address decoder 520 and may provide the column address C_ADDR to the data I/O circuit 540.

The address decoder 520 may be connected to the memory cell array 510 via the plurality of string selection lines SSL, the plurality of wordlines WL and the plurality of ground selection lines GSL.

For example, in the data erase/write/read operations, the address decoder 520 may determine at least one of the plurality of wordlines WL as a selected wordline, and may determine the remaining wordlines, other than the selected wordline, as unselected wordlines, based on the row address R_ADDR.

In addition, in the data erase/write/read operations, the address decoder 520 may determine at least one of the plurality of string selection lines SSL as a selected string selection line, and may determine the remaining string selection lines, other than the selected string selection line, as unselected string selection lines, based on the row address R_ADDR.

Further, in the data erase/write/read operations, the address decoder 520 may determine at least one of the plurality of ground selection lines GSL as a selected ground selection line, and may determine the remaining ground selection lines, other than the selected ground selection line, as unselected ground selection lines, based on the row address R_ADDR.

The voltage generator 550 may generate voltages VS that are required for an operation of the nonvolatile memory 500 based on a power PWR and the control signals CON. The voltages VS may be applied to the plurality of string selection lines SSL, the plurality of wordlines WL and the plurality of ground selection lines GSL via the address decoder 520. In addition, the voltage generator 550 may generate an erase voltage that is required for the data erase operation based on the power PWR and the control signals CON. The erase voltage may be applied to the memory cell array 510 directly or via the bitline BL.

For example, during the erase operation, the voltage generator 550 may apply the erase voltage to a common source line and/or the bitline BL of a memory block (e.g., a selected memory block) and may apply an erase permission voltage (e.g., a ground voltage) to all wordlines of the memory block or a portion of the wordlines via the address decoder 520. In addition, during the erase verification operation, the voltage generator 550 may apply an erase verification voltage simultaneously to all wordlines of the memory block or sequentially to the wordlines one by one.

For example, during the program operation, the voltage generator 550 may apply a program voltage to the selected wordline and may apply a program pass voltage to the unselected wordlines via the address decoder 520. In addition, during the program verification operation, the voltage generator 550 may apply a program verification voltage to the selected wordline and may apply a verification pass voltage to the unselected wordlines via the address decoder 520.

In addition, during the normal read operation, the voltage generator 550 may apply a read voltage to the selected wordline and may apply a read pass voltage to the unselected wordlines via the address decoder 520. During the data recover read operation, the voltage generator 550 may apply the read voltage to a wordline adjacent to the selected wordline and may apply a recover read voltage to the selected wordline via the address decoder 520.

The page buffer circuit 530 may be connected to the memory cell array 510 via the plurality of bitlines BL. The page buffer circuit 530 may include a plurality of page buffers. In some example embodiments, each page buffer may be connected to one bitline. In other example embodiments, each page buffer may be connected to two or more bitlines.

The page buffer circuit 530 may store data DAT to be programmed into the memory cell array 510 or may read data DAT sensed (i.e., read) from the memory cell array 510. In other words, the page buffer circuit 530 may operate as a write driver or a sensing amplifier according to an operation mode of the nonvolatile memory 500.

The data I/O circuit 540 may be connected to the page buffer circuit 530 via data lines DL. The data I/O circuit 540 may provide the data DAT from the outside of the nonvolatile memory 500 to the memory cell array 510 via the page buffer circuit 530 or may provide the data DAT from the memory cell array 510 to the outside of the nonvolatile memory 500, based on the column address C_ADDR.

Although the nonvolatile memory is described based on a NAND flash memory, example embodiments are not limited thereto, and the nonvolatile memory may be any nonvolatile memory, e.g., a phase random access memory (PRAM), a resistive random access memory (RRAM), a nano floating gate memory (NFGM), a polymer random access memory (PoRAM), a magnetic random access memory (MRAM), a ferroelectric random access memory (FRAM), a thyristor random access memory (TRAM), or the like.

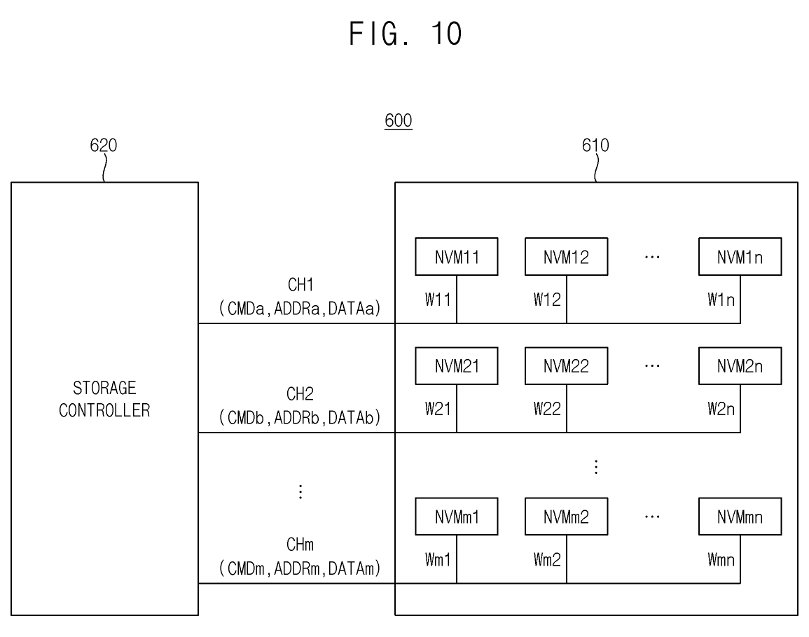

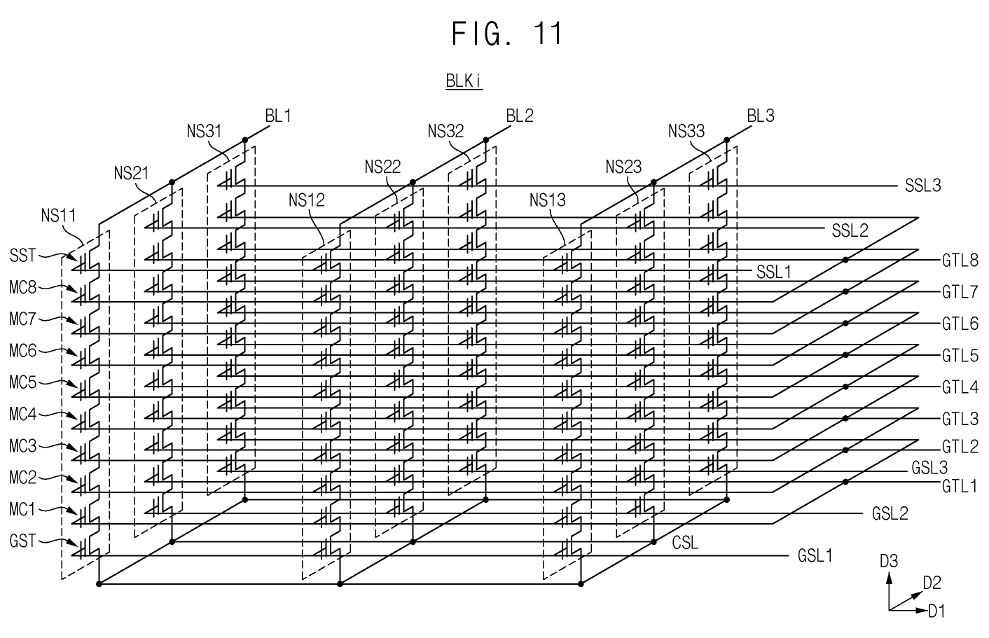

FIG. 10 is a block diagram illustrating a storage device according to example embodiments.

Referring to FIG. 10, a storage device 600 may include a memory device 610 and a memory controller 620. The storage device 600 may support a plurality of channels CH1, CH2, ..., CHm, and the memory device 610 may be connected to the memory controller 620 through the plurality of channels CH1 to CHm. For example, the storage device 600 may be implemented as a storage device, such as a universal flash storage (UFS), and a solid state drive (SSD).

The memory device 610 may include a plurality of nonvolatile memories NVM11, NVM12, ..., NVM1n, NVM21, NVM22, ..., NVM2n, NVMm1, NVMm2, ..., NVMmn. For example, the nonvolatile memories NVM11 to NVMmn may correspond to the nonvolatile memory device 320a, 320b and 320c in FIG. 1. Each of the nonvolatile memories NVM11 to NVMmn may be connected to one of the plurality of channels CH1 to CHm through a way corresponding thereto. For instance, the nonvolatile memories NVM11 to NVM1n may be connected to the first channel CH1 through ways W11, W12, ..., W1n, the nonvolatile memories NVM21 to NVM2n may be connected to the second channel CH2 through ways W21, W22, ..., W2n, and the nonvolatile memories NVMm1 to NVMmn may be connected to the m-th channel CHm through ways Wm1, Wm2, ..., Wmn. In some example embodiments, each of the nonvolatile memories NVM11 to NVMmn may be implemented as a memory unit that may operate according to an individual command from the memory controller 620. For example, each of the nonvolatile memories NVM11 to NVMmn may be implemented as a chip or a die, but example embodiments are not limited thereto.

The memory controller 620 may transmit and receive signals to and from the memory device 610 through the plurality of channels CH1 to CHm. For example, the memory controller 620 may correspond to the storage controller 310 in FIG. 1. For example, the memory controller 620 may transmit commands CMDa, CMDb, ..., CMDm, addresses ADDRa, ADDRb, ..., ADDRm and data DATAa, DATAb, ..., DATAm to the memory device 610 through the channels CH1 to CHm, or may receive the data DATAa to DATAm from the memory device 610 through the channels CH1 to CHm.

The memory controller 620 may select one of the nonvolatile memories NVM11 to NVMmn, which is connected to each of the channels CH1 to CHm, using a corresponding one of the channels CH1 to CHm, and may transmit and receive signals to and from the selected nonvolatile memory. For example, the memory controller 620 may select the nonvolatile memory NVM11 from among the nonvolatile memories NVM11 to NVM1n connected to the first channel CH1. The memory controller 620 may transmit the command CMDa, the address ADDRa and the data DATAa to the selected nonvolatile memory NVM11 through the first channel CH1 or may receive the data DATAa from the selected nonvolatile memory NVM11 through the first channel CH1.

The memory controller 620 may transmit and receive signals to and from the memory device 610 in parallel through different channels. For example, the memory controller 620 may transmit the command CMDb to the memory device 610 through the second channel CH2 while transmitting the command CMDa to the memory device 610 through the first channel CH1. For example, the memory controller 620 may receive the data DATAb from the memory device 610 through the second channel CH2 while receiving the data DATAa from the memory device 610 through the first channel CH1.

The memory controller 620 may control overall operations of the memory device 610. The memory controller 620 may transmit a signal to the channels CH1 to CHm and may control each of the nonvolatile memories NVM11 to NVMmn connected to the channels CH1 to CHm. For example, the memory controller 620 may transmit the command CMDa and the address ADDRa to the first channel CH1 and may control one selected from among the nonvolatile memories NVM11 to NVM1n.

Each of the nonvolatile memories NVM11 to NVMmn may operate under the control of the memory controller 620. For example, the nonvolatile memory NVM11 may program the data DATAa based on the command CMDa, the address ADDRa and the data DATAa provided from the memory controller 620 through the first channel CH1. For example, the nonvolatile memory NVM21 may read the data DATAb based on the command CMDb and the address ADDRb provided from the memory controller 620 through the second channel CH2 and may transmit the read data DATAb to the memory controller 620 through the second channel CH2.

Although FIG. 10 illustrates an example where the memory device 610 communicates with the memory controller 620 through m channels and includes n nonvolatile memories corresponding to each of the channels, example embodiments are not limited thereto and the number of channels and the number of nonvolatile memories connected to one channel may be variously changed.

FIG. 11 is a circuit diagram illustrating an equivalent circuit of a memory block included in a nonvolatile memory device included in a storage device according to example embodiments.

Referring to FIG. 11, each memory block BLKi included in a memory cell array 510 in FIG. 19 may be formed on a substrate in a three-dimensional structure (or a vertical structure). For example, NAND strings or cell strings included in the memory block BLKi may be formed in a vertical direction D3 perpendicular to an upper surface of a substrate. A first direction D1 and a second direction D2 are parallel to the upper surface of the substrate.

The memory block BLKi may include NAND strings NS11 to NS33 coupled between bitlines BL1, BL2, and BL3 and a common source line CSL. Each of the NAND strings NS11 to NS33 may include a string selection transistor SST, a memory cells MC1 to MC8, and a ground selection transistor GST. In FIG. 11, each of the NAND strings NS11 to NS33 is illustrated to include eight memory cells MC1 to MC8. However, example embodiments are not limited thereto, and each of the NAND strings NS11 to NS33 may include various numbers of memory cells.

Each string selection transistor SST may be connected to a corresponding string selection line (one of SSL1 to SSL3). The memory cells MC1 to MC8 may be connected to corresponding gate lines GTL1 to GTL8, respectively. The gate lines GTL1 to GTL8 may be wordlines, and some of the gate lines GTL1 to GTL8 may be dummy wordlines. Each ground selection transistor GST may be connected to a corresponding ground selection line (one of GSL1 to GSL3). Each string selection transistor SST may be connected to a corresponding bitline (e.g., one of BL1, BL2, and BL3), and each ground selection transistor GST may be connected to the common source line CSL.

Wordlines (e.g., WL1) having the same height may be commonly connected, and the ground selection lines GSL1 to GSL3 and the string selection lines SSL1 to SSL3 may be separated. In FIG. 11, the memory block BLKi is illustrated as being coupled to eight gate lines GTL1 to GTL8 and three bitlines BL1 to BL3. However, example embodiments are not limited thereto, and each memory block in the memory cell array 510 may be coupled to various numbers of wordlines and various numbers of bitlines.

FIG. 12 is a diagram illustrating an example embodiment of a data move operation and a metadata update operation in a method of relocating data of a storage system according to example embodiments, and FIG. 13 is a diagram illustrating an example embodiment of a move data descriptor corresponding to the data move operation of FIG. 12.

FIG. 12 illustrates an example of relocating first to seventh data blocks DB1 to DB7 stored and distributed in a memory block MB1 of a nonvolatile memory device 320 to another memory block MB2.

Referring to FIG. 12, the first to seventh data blocks DB1 to DB7 that are subject to relocation may be grouped into a plurality of data groups, such as first to fourth data groups G1 to G4 which are distributed over non-contiguous physical addresses. The first to fourth data groups G1 to G4 may be referred to as fragmented. Each group may be a single data block storing data or two or more data blocks consecutively adjacent to each other storing data. For example, each of the first data group G1 and the third data group G3 is consisted of a single data block. The second data group G2 is consisted of two data blocks DB2 and DB3 which are stored at contiguous physical addresses. The fourth data group G4 is consisted of three data blocks DB5, DB6, and DB7 which are stored at contiguous physical addresses. When data of a file are scattered over the first to fourth data group G1 to G4 which are stored at non-contiguous physical addresses of the nonvolatile memory device 320, such fragmented data of the same file stored in the nonvolatile memory device 320 may cause unnecessary write amplification in which unnecessary more write operations occur, disrupt the flash memory controller’s wear-leveling and garbage collection strategies, or confuse or interfere with FTL optimizations thereby reducing efficiency. To remove fragmented data of the same file, a defragmentation operation may be performed using a synchronous move request according to an embodiment of the present disclosure.

Referring to FIG. 13, the move data descriptor MVDRT may include first to fourth data entries ENT1 to ENT4 respectively corresponding to the first to fourth data groups G1 to G4. NB indicates the number of data blocks included in each data group. In this case, the group count GC indicating the number of data entries ENT1 to ENT4 included in the move data descriptor MVDRT has a value of 4.

Based on this move data descriptor MVDRT, the storage device 301 may perform a data move operation DMO. At this time, the flash translation layer FTL of the storage device 301 may perform an address mapping between logical addresses and physical addresses of the first to seventh data blocks DB1 to DB7 after the relocation such that the first to seventh data blocks DB1 to DB7 are stored in physical proximity by the data move operation DMO. The logical address which will be mapped to the first to seventh data blocks DB1 to BD7 after the relocation will be provided by the move data descriptor MVDRT from the host device 200.

For example, as shown in FIG. 12, the flash translation layer FTL may perform address mapping such that the first to fourth data blocks DB1 to DB4 are stored in one and the same page PG1 and the fifth to seventh data blocks DB5 to DB7 are stored in another and the same page PG2.

The storage device 301 may perform the metadata update operation NMUO after the data move operation DMO is completed. By the metadata update operation NMUO, the system metadata NSMD before the relocation may be replaced with the system metadata NSMD' after the relocation.

As described above with reference to FIG. 5, the storage device 301 may, upon completion of the data move operation DMO and the metadata update operation NMUO, transfer or issue a response RSP indicating a success SS of the data relocation to the host device 200 (S15). Upon receiving the response RSP indicating the success SS of the relocation, the host device 200 may update the old system metadata FSMD stored in the host device 200 with the new system metadata FSMD' (S16). As a result, after the relocation of the data blocks DB1 to DB7 in the memory block MB1 to the data blocks DB1 to DB7 in the memory block MB2 is successfully completed, the new system metadata FSMD‘ stored in the host device 200 and the nonvolatile system metadata NSMD’ stored in the nonvolatile memory device 320 may all be consistent. If the SPO occurs during the command transmission of the synchronous move request SMREQ in step S12 or during the response reception process of the response RSP in step S15, the host device 200 cannot determine whether the synchronous move request SMREQ was successfully executed. However, the synchronous move request SMREQ guarantees that the system device will be in either the previous state before data relocation (e.g., the system metadata FSMD) or the new state (e.g., the new system metadata FSMD’) after data relocation. If the storage device 301 transmits the response RSP, the host device 200 which is in the new state has the new system metadata FSMD’ updated by the data relocation, which will be described with reference to FIGS. 5 and 12. If the response RSP was not transmitted, the previous state of the host device 200 is guaranteed by keeping the system metadata FSMD.

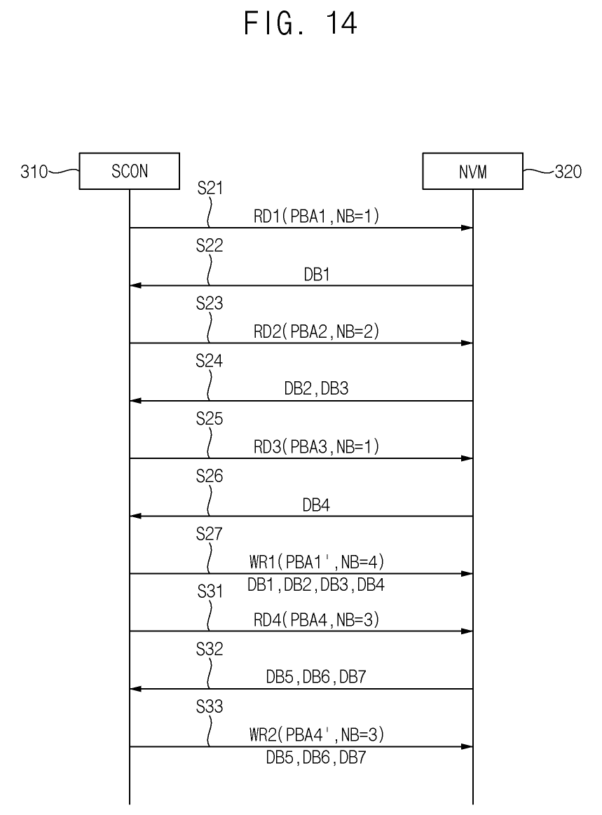

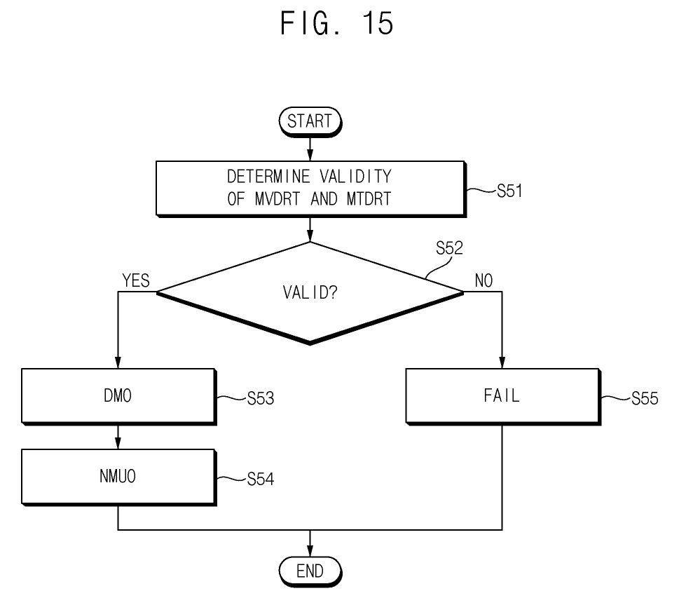

FIG. 14 is a sequence diagram illustrating an example embodiment of operations of a storage device corresponding to the data move operation of FIG. 12.

Referring to FIGS. 12 to 14, the storage controller 310 may transfer or issue a first read command RD1 to the nonvolatile memory device 320 (S21) based on a first data entry ENT1 of the move data descriptor MVDRT. The flash translation layer FTL may map a physical address PBA1 to the logical address LBA1 by reference to a mapping table. The first read command RD1 may include the physical address PBA1 corresponding to the start address of the first data group G1 and the number of data blocks NB=1. The nonvolatile memory device 301 may read the first data block DB1 based on the first read command RD1 and provide the first data block DB1 to the storage controller 310 (S22).

The storage controller 310 may then transfer or issue a second read command RD2 to the nonvolatile memory device 320 based on the second data entry ENT2 of the move data descriptor MVDRT (S23). The flash translation layer FTL may map a physical address PBA2 to the logical address LBA2 by reference to the mapping table. The second read command RD2 may include the physical address PBA2 corresponding to the start address of the second data group G2 and the number of data blocks NB=2. Based on the second read command RD2, the nonvolatile memory device 301 may read the second data block DB2 and the third data block DB3 and provide the second and third data blocks DB2 and DB2 to the storage controller 310 (S24).

Subsequently, the storage controller 310 may transfer or issue a third read command RD3 to the nonvolatile memory device 320 based on the third data entry ENT3 of the move data descriptor MVDRT (S25). The flash translation layer FTL may map a physical address PBA3 to the logical address LBA3 by reference to the mapping table. The third read command RD3 may include the physical address PBA3 corresponding to the start address of the third data group G3 and the number of data blocks NB=1. The nonvolatile memory device 301 may read a fourth data block DB4 based on the third read command RD3 and provide it to the storage controller 310 (S24).

In this way, after the first to fourth data blocks DB1 to DB4 corresponding to one page have been read out, the storage controller 310 may transmit a first write command WR1 to the nonvolatile memory device 320 (S27). The flash translation layer (FTL) may map the logical address LBA1‘ to the physical address PBA1’. The logical address LBA1’ associated with the relocated data blocks DB1 to BD4 may be set in advance in the move data descriptor MVDRT received from the host device 200. The first write command WR1 may include the physical address PBA1' corresponding to the start address of the first page PG1 of the memory block MB2 and the number of data blocks NB=4. Meanwhile, the storage controller 310 may transmit the first to fourth data blocks DB1 to DB4 to the nonvolatile memory device 320 with the first write command WR1. The nonvolatile memory device 320 may store the first to fourth data blocks DB1 to DB4 in the first page PG1 of the memory block MB2 based on the first write command WR1.

Subsequently, the storage controller 310 may transfer or issue a fourth read command RD4 to the nonvolatile memory device 320 (S31) based on the fourth data entry ENT4 of the move data descriptor MVDRT. The flash translation layer (FTL) may provide a physical address PBA4 mapped to the logical address LBA4 by reference to the mapping table. The fourth read command RD4 may include the physical address PBA4 corresponding to the start address of the fourth data group G4 and the number of data blocks NB=3. The nonvolatile memory device 301 may read the fifth to seventh data blocks DB5 to DB7 based on the fourth read command RD4 and provide the fifth to seventh data blocks DB5 to DB7 to the storage controller 310 (S32).

As such, after all of the data blocks to be relocated have been read out, the storage controller 310 may transfer or issue a second write command WR2 to the nonvolatile memory device 320 (S33). The flash translation layer FTL may map the logical address LBA4‘ to the physical address PBA4’. The logical address LBA4’ associated with the relocated data blocks DB4 to BD7 may be set in advance in the move data descriptor MVDRT received from the host device 200. The second write command WR2 may include the physical address PBA4' corresponding to the start address of the second page PG2 of the memory block MB2 and the number of data blocks NB=3. Meanwhile, the storage controller 310 may transmit the fifth to seventh data blocks DB5 to DB7 to the nonvolatile memory device 320 with the second write command WR2. The nonvolatile memory device 320 may store the fifth to seventh data blocks DB5 to DB7 in the second page PG2 of the memory block MB2 based on the second write command WR2.

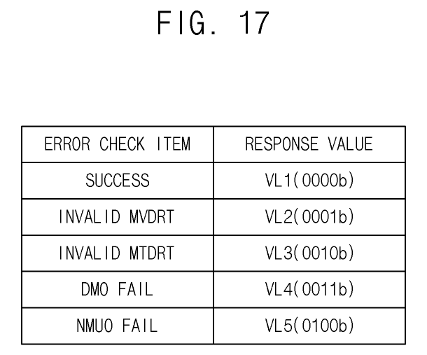

FIGS. 15 and 16 are flowcharts illustrating example embodiments of operations of a storage device according to example embodiments, and FIG. 17 is a diagram illustrating example embodiments of response values in a method of relocating data of a storage system according to example embodiments.

Referring to FIG. 15, the storage device 301 may determine the validity of a move data descriptor MVDRT transferred from the host device 200 and the validity of a metadata descriptor MTDRT transferred from the host device 200 (S51). In an embodiment, a consistency check (or integrity check) may be performed to verify whether the data structure of the move data descriptor MVDRT or the data structure of the metadata descriptor MTDRT conforms to expected rules, formats, or values. If a sudden power outage occurs during transmission of the move data descriptor (MVDRT) or the metadata descriptor (MTDRT), the transmission may be incomplete. As a result, a consistency check may detect abnormalities in the data structure of the MVDRT or MTDRT and determine it to be invalid.

If both the move data descriptor MVDRT and the metadata descriptor MTDRT are valid (S52: YES), the storage device 301 may sequentially perform the data move operation DMO and the metadata update operation NMUO (S53 and S54).

The storage device 301 may determine a failure of the data relocation (S55) if at least one of the move data descriptor MVDRT and the metadata descriptor MTDRT is invalid (S52: NO). In this case, as described above, the storage device 301 may transfer or issue a response indicating the failure of the data relocation to the host device 200.

Referring to FIGS. 16 and 17, the storage device 301 may receive the synchronous move request SMREQ including the move data descriptor MVDRT and the metadata descriptor MTDRT from the host device 200 (S61). The format of the move data descriptor MVDRT and the format of the metadata descriptor MTDRT are described with reference to FIGS. 6 and 7.

The storage device 301 may determine the validity of the move data descriptor MVDRT (S62), and if the move data descriptor MVDRT is invalid (S63: NO), the storage device 301 may transfer or issue a response RSP with a second value VL2 corresponding to a relocation failure FL to the host device 200 (S90).

If the move data descriptor MVDRT is valid (S63: YES), the storage device 301 may determine the validity of the metadata descriptor MTDRT (S64). If the metadata descriptor MTDRT is invalid (S65: NO), the storage device 301 may transfer or issue a response RSP to the host device 200 with a third value VL3 corresponding to a relocation failure FL (S90).

If the metadata descriptor MTDRT is valid (S65: YES), the storage device 301 may perform the data move operation DMO (S66). If the data move operation DMO fails (S67: NO), the storage device 301 may transfer or issue a response RSP with a fourth value VL4 corresponding to a relocation failure FL to the host device 200 (S90).

Upon successful completion of the data move operation DMO (S67: YES), the storage device 301 may perform the metadata update operation NMUO (S68). If the metadata update operation NMUO fails (S69: NO), the storage device 301 may transfer or issue a response RSP with a fifth value VL5 corresponding to a relocation failure FL to the host device 200 (S90).

Upon successful completion of the metadata update operation NMUO (S69: YES), the storage device 301 may delete (or unmap) the address mappings related with the logical addresses LBA of the plurality of data blocks before the data relocation (S70). The UNMAP operation is a metadata-level command issued by the host device 200 (such as a smartphone OS) to inform the storage device 301 that certain logical block addresses (LBAs) are no longer in use, typically after a file is deleted or an application clears data. Instead of immediately erasing the physical data, the device’s flash translation layer FTL simply marks the associated mappings as invalid, allowing those blocks to be reclaimed later during garbage collection. This improves performance, reduces write amplification, and extends flash lifespan. In UFS-based storage, for example, the UNMAP command (based on SCSI protocols) transmits only the LBA ranges to discard, and the storage device 301 updates its internal mapping table without moving or erasing any data at that time.

Thereafter, the storage device 301 may transfer or issue a response RSP having a first value VL1 corresponding to a success SS of the data relocation to the host device 200 (S80).

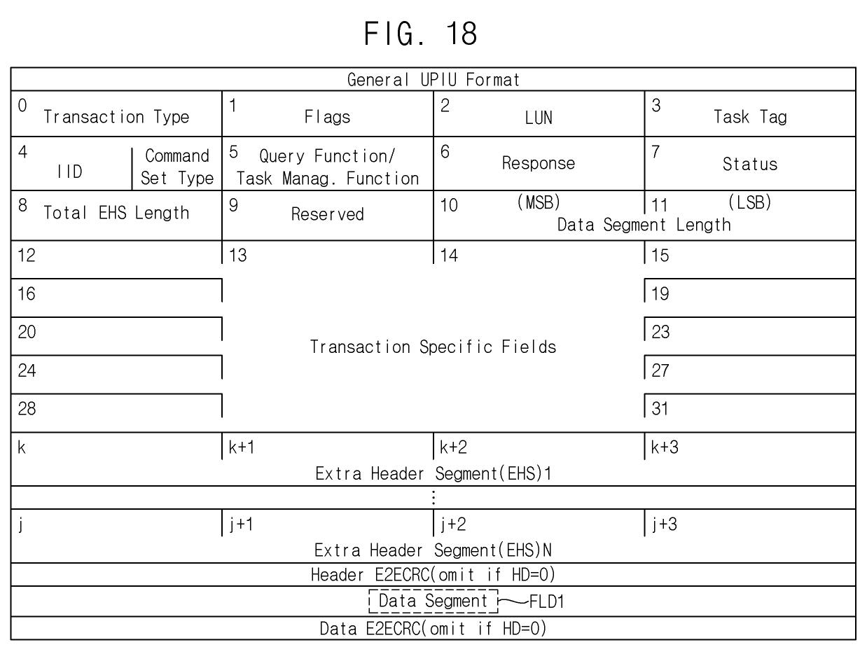

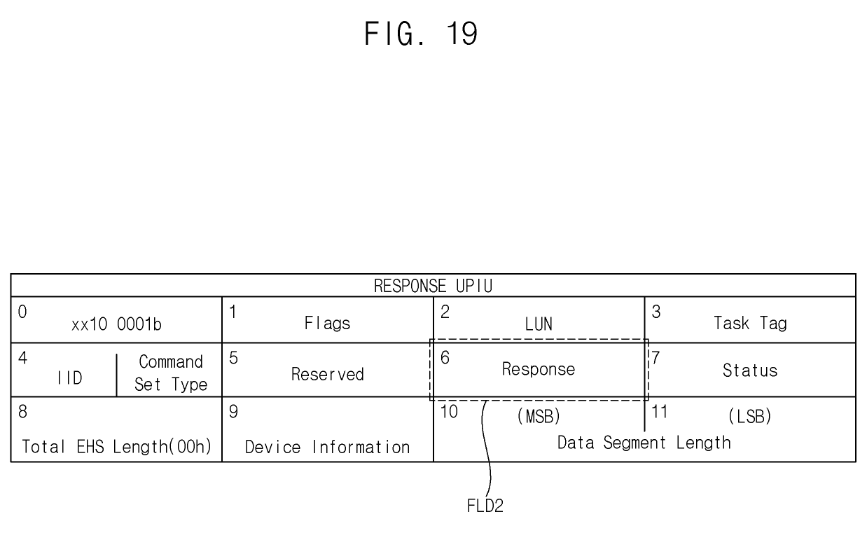

FIGS. 18 and 19 are diagrams illustrating a UFS Protocol Information Unit (UPIU) used in a method of relocating data of a storage system according to example embodiments.

FIG. 18 illustrates a generic format of a UPIU according to the UFS standard. The UPIU includes a plurality of fields, and FIG. 18 shows the byte number (0 to j+3) and name for each field. For example, the UPIU may include fields such as Transaction Type, Flags, LUN, Task Tag, IID, Command Set Type, Query Function/Task Management Function, Response, Total EHS Length (00h), Device Information, Data Segment Length, Transaction Specific Fields, Extra Header Segment (EHS)1 to Extra Header Segment (EHS)N, Header E2ECRC, Data Segment, and Data E2ECRC. The descriptions for each of these fields are replaced with descriptions disclosed in the UFS standard. The disclosure of [Standard Name, version/date], published by [Standard Body], is hereby incorporated by reference in its entirety."

The host device 200 may transfer or issue the synchronous move request SMREQ described above to the storage device 301 using a UPIU in accordance with the UFS standard as shown in FIG. 18. For example, the move data descriptor MVDRT and metadata descriptor MTDRT may be included in the data segment field FLD1.

FIG. 19 illustrates a header portion of a response UPIU according to the UFS standard. The storage device 301 may transfer or issue the aforementioned response RSP to the host device 200 using the response UPIU according to the UFS standard as shown in FIG. 19. For example, the response value of FIG. 17 may be included in the Response field FLD2 of the response UPIU.

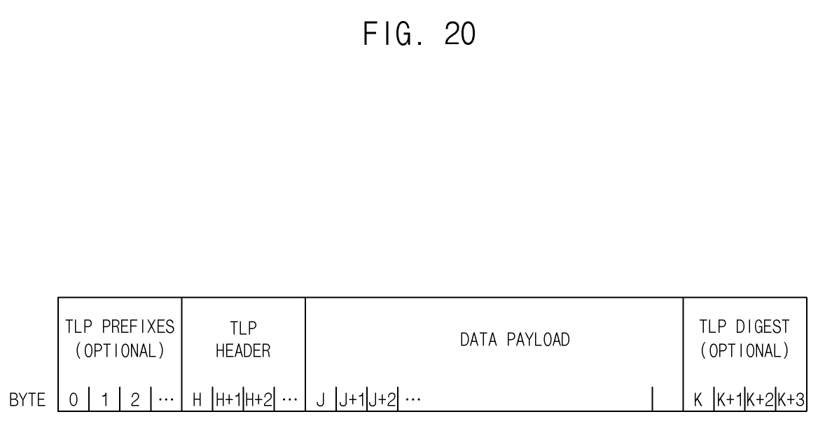

FIG. 20 is a diagram illustrating an example embodiment of a packet used in a method of relocating data of a storage system according to example embodiments.

FIG. 20 illustrates the format of a transaction layer packet (TLP) generated and managed by the transaction layer of a PCIe architecture.

Transactions include requests and completions (or responses) and are communicated using packets. As shown in FIG. 20, a transaction layer packet (TLP) may include fields such as one or more optional TLP prefixes of a plurality of bytes (BYTE 0 to k+3), a TLP header, a data payload, and an optional digest.

The synchronous move request SMREQ and the response RSP described above may correspond to a TLP as shown in FIG. 20. The TLP header may include various information, such as a device identifier, a response value indicating the success or failure of various actions, and a data payload, which may include the move data descriptor MVDRT and the metadata descriptor MTDRT as described above.

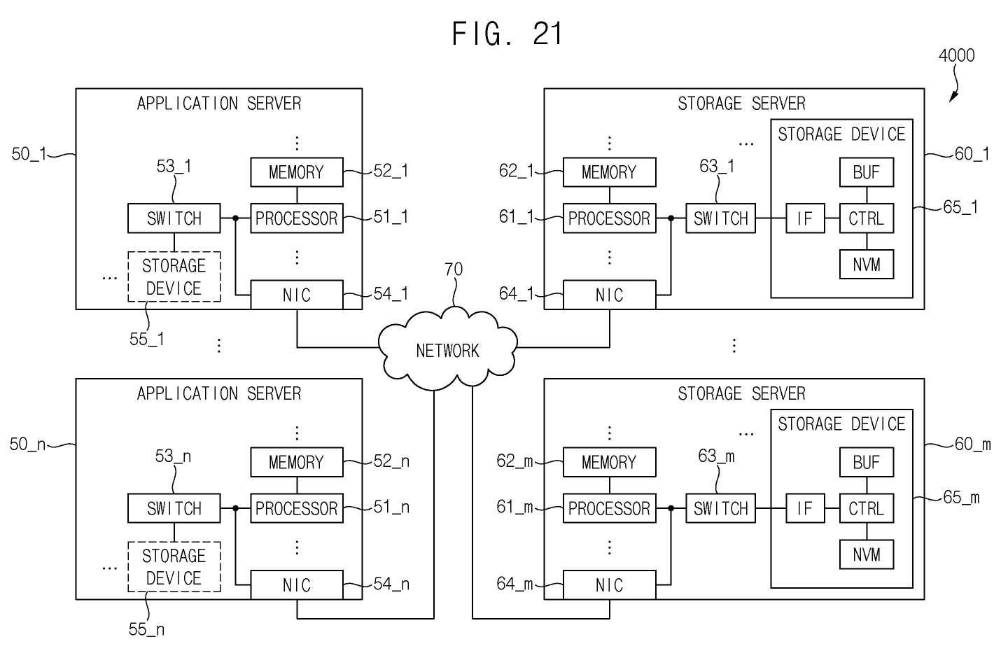

FIG. 21 is a block diagram illustrating a data center including a storage system according to example embodiments.

In some example embodiments, the storage device described above with reference to FIGS. 1 through 20 may serve as an application server and/or a storage server and may be included in a data center 4000.

Referring to FIG. 21, the data center 4000 may collect various pieces of data and provide services and be also referred to as a data storage center. For example, the data center 4000 may be a system configured to operate a search engine and a database or a computing system used by companies, such as banks, or government agencies. As shown in FIG. 21, the data center 4000 may include application servers 50_1 to 50_n and storage servers 60_1 to 60_m (where, each of m and n is an integer more than 1). The number n of application servers 50_1 to 50_n and the number m of storage servers 60_1 to 60_m may be variously selected according to example embodiments. In some example embodiments, the number n of application servers 50_1 to 50_n may be different from the number m of storage servers 60_1 to 60_m.

The application servers 50_1 to 50_n may include any one or any combination of processors 51_1 to 51_n, memories 52_1 to 52_n, switches 53_1 to 53_n, network interface controllers (NICs) 54_1 to 54_n, and storage devices 55_1 to 55_n. The processors 51_1 to 51_n may control all operations of the application servers 50_1 to 50_n, access the memories 52_1 to 52_n, and execute instructions and/or data loaded in the memories 52_1 to 52_n. Non-limiting examples of the memories 52_1 to 52_n may include DDR SDRAM, a high-bandwidth memory (HBM), a hybrid memory cube (HMC), a dual in-line memory module (DIMM), a Optane DIMM, or a nonvolatile DIMM (NVDIIMM).

According to example embodiments, the numbers of processors and memories included in the application servers 50_1 to 50_n may be variously selected according to example embodiments. In some example embodiments, the processors 51_1 to 51_n and the memories 52_1 to 52_n may provide processor-memory pairs. In some example embodiments, the number of processors 51_1 to 51_n may be different from the number of memories 52_1 to 52_n. The processors 51_1 to 51_n may include a single core processor or a multi-core processor. In some example embodiments, as illustrated with a dashed line in FIG. 21, the storage devices 55_1 to 55_n may be omitted from the application servers 50_1 to 50_n. The number of storage devices 55_1 to 55_n included in the storage servers 50_1 to 50_n may be variously selected according to example embodiments. The processors 51_1 to 51_n, the memories 52_1 to 52_n, the switches 53_1 to 53_n, the NICs 54_1 to 54_n, and/or the storage devices 55_1 to 55_n may communicate with each other through a link described above with reference to the drawings.

The storage servers 60_1 to 60_m may include any one or any combination of processors 61_1 to 61_m, memories 62_1 to 62_m, switches 63_1 to 63_m, network interface controllers (NICs) 64_1 to 64_n, and storage devices 65_1 to 65_m. The processors 61_1 to 61_m and the memories 62_1 to 62_m may operate similar to the processors 51_1 to 51_n and the memories 52_1 to 52_n of the application servers 50_1 to 50_n described above.

The application servers 50_1 to 50_n may communicate with the storage servers 60_1 to 60_m through a network 70. In some example embodiments, the network 70 may be implemented using a fiber channel (FC) or Ethernet. The FC may be a medium used for relatively high-speed data transfer. An optical switch that provides high performance and high availability may be used as the FC. The storage servers 60_1 to 60_m may be provided as file storages, block storages, or object storages according to an access method of the network 70.

In some example embodiments, the network 70 may be a storage-only network, such as a storage area network (SAN). For example, the SAN may be an FC-SAN, which may use an FC network and be implemented using an FC Protocol (FCP). In another case, the SAN may be an Internet protocol (IP)-SAN, which uses a transmission control protocol/Internet protocol (TCP/IP) network and is implemented according to an SCSI over TCP/IP or Internet SCSI (iSCSI) protocol. In some example embodiments, the network 70 may be a general network, such as a TCP/IP network. For example, the network 70 may be implemented according to a protocol, such as FC over Ethernet (FCoE), network attached storage (NAS), and nonvolatile memory express (NVMe) over fabrics (NVMe-oF).

The application server 50_1 and the storage server 60_1 will mainly be described, but it may be noted that a description of the application server 50_1 may be also applied to another application server (e.g., 50_n), and a description of the storage server 60_1 may be also applied to another storage server (e.g., 60_m).

The application server 50_1 may store data, which is requested to be stored by a user or a client, in one of the storage servers 60_1 to 60_m through the network 70. In some example embodiments, the application server 50_1 may obtain data, which is requested to be read by the user or the client, from one of the storage servers 60_1 to 60_m through the network 70. For example, the application server 50_1 may be implemented using a web server or a database management system (DBMS).

The application server 50_1 may access the memory 52_n and/or the storage device 55_n included in another application server 50_n, through the network 70, and/or access the memories 62_1 to 62_m and/or the storage devices 65_1 to 65_m included in the storage servers 60_1 to 60_m, through the network 70. Accordingly, the application server 50_1 may perform various operations on data stored in the application servers 50_1 to 50_n and/or the storage servers 60_1 to 60_m. For example, the application server 50_1 may execute an instruction to migrate or copy data between the application servers 50_1 to 50_n and/or the storage servers 60_1 to 60_m. In this case, the data may be migrated from the storage devices 65_1 to 65_m of the storage servers 60_1 to 60_m to the memories 52_1 to 52_n of the application servers 50_1 to 50_n through the memories 62_1 to 62_m of the storage servers 60_1 to 60_m or directly. In some example embodiments, the data migrated through the network 70 may be encrypted data for security or privacy.

In the storage server 60_1, an interface IF may provide physical connection between the processor 61_1 and a controller CTRL and physical connection between the NIC 64_1 and the controller CTRL. For example, the interface IF may be implemented using a direct attached storage (DAS) method in which the storage device 65_1 is directly connected to a dedicated cable. For example, the interface IF may be implemented using various interface methods, such as advanced technology attachment (ATA), serial ATA (SATA), external SATA (e-SATA), small computer small interface (SCSI), serial attached SCSI (SAS), PCI, PCIe, NVMe, IEEE 1394, a universal serial bus (USB), a secure digital (SD) card, a multi-media card (MMC), an embedded MMC (eMMC), a UFS, an embedded UFS (eUFS), and a compact flash (CF) card interface.

In the storage server 60_1, the switch 63_1 may selectively connect the processor 61_1 to the storage device 65_1 or selectively connect the NIC 64_1 to the storage device 65_1 based on the control of the processor 61_1.

In some example embodiments, the network interface controller (NIC) 64_1 may include a network interface card and a network adaptor. The NIC 54_1 may be connected to the network 70 through a wired interface, a wireless interface, a Bluetooth interface, or an optical interface. The NIC 54_1 may include an internal memory, a digital signal processor (DSP), and a host bus interface and be connected to the processor 61_1 and/or the switch 63_1 through the host bus interface. In some example embodiments, the NIC 64_1 may be integrated with any one or any combination of the processor 61_1, the switch 63_1, and the storage device 65_1.

In the application servers 50_1 to 50_n or the storage servers 60_1 to 60_m, the processors 51_1 to 51_m and 61_1 to 61_n may transmit commands to the storage devices 55_1 to 55_n and 65_1 to 65_m or the memories 52_1 to 52_n and 62_1 to 62_m and program or read data. In this case, the data may be data of which an error is corrected by an error correction code (ECC) engine. The data may be data processed with data bus inversion (DBI) or data masking (DM) and include cyclic redundancy Code (CRC) information. The data may be encrypted data for security or privacy.

In response to read commands received from the processors 51_1 to 51_m and 61_1 to 61_n, the storage devices 55_1 to 55_n and 65_1 to 65_m may transmit control signals and command/address signals to a nonvolatile memory device (e.g., a NAND flash memory device) NVM. Accordingly, when data is read from the nonvolatile memory device NVM, a read enable signal may be input as a data output control signal to output the data to a DQ bus. A data strobe signal may be generated using the read enable signal. The command and the address signal may be latched according to a rising edge or falling edge of a write enable signal.

The controller CTRL may control all operations of the storage device 65_1. In example embodiments, the controller CTRL may include static RAM (SRAM). The controller CTRL may write data to the nonvolatile memory device NVM in response to a write command or read data from the nonvolatile memory device NVM in response to a read command. For example, the write command and/or the read command may be generated based on a request provided from a host (e.g., the processor 61_1 of the storage server 60_1, the processor 61_m of another storage server 60_m, or the processors 51_1 to 51_n of the application servers 50_1 to 50_n). A buffer BUF may temporarily store (or buffer) data to be written to the nonvolatile memory device NVM or data read from the nonvolatile memory device NVM. In some example embodiments, the buffer BUF may include DRAM. The buffer BUF may store metadata. The metadata may refer to user data or data generated by the controller CTRL to manage the nonvolatile memory device NVM. The storage device 65_1 may include a secure element (SE) for security or privacy.

As described above, the storage system and the data relocation method of the storage system according to example embodiments may perform data relocation efficiently by performing the data move operation and the metadata update operation based on a single synchronous move request, while ensuring consistency between system metadata and user data.

As will be appreciated by one skilled in the art, example embodiments may be implemented as a system, method, computer program product, or a computer program product embodied in one or more computer readable medium(s) having computer readable program code embodied thereon. The computer readable program code may be provided to a processor of a general purpose computer, special purpose computer, or other programmable data processing apparatus. The computer readable medium may be a computer readable signal medium or a computer readable storage medium. The computer readable storage medium may be any tangible medium that can contain, or store a program for use by or in connection with an instruction execution system, apparatus, or device.

The various example embodiments may be applied to any electronic devices and systems including a nonvolatile memory device. For example, the various example embodiments may be applied to systems such as a memory card, a solid state drive (SSD), an embedded multimedia card (eMMC), a universal flash storage (UFS), a mobile phone, a smart phone, a personal digital assistant (PDA), a portable multimedia player (PMP), a digital camera, a camcorder, a personal computer (PC), a server computer, a workstation, a laptop computer, a digital TV, a set-top box, a portable game console, a navigation system, a wearable device, an internet of things (IoT) device, an internet of everything (IoE) device, an e-book, a virtual reality (VR) device, an augmented reality (AR) device, a server system, a data center, and an automotive driving system.

The foregoing is illustrative of various example embodiments and is not to be construed as limiting thereof. Although a few example embodiments have been described, those skilled in the art will readily appreciate that many modifications are possible in the example embodiments without materially departing from the scope as defined by the appended claims.

What is claimed is:

1. A storage system comprising:
a storage device including a nonvolatile memory device configured to store a plurality of data blocks associated with a file; and
a host device including a file system configured to update a first file system metadata with a second file system metadata to manage the plurality of data blocks stored in the nonvolatile memory device, wherein each of the first file system metadata and the second file system metadata is a data structure representing information about the file,
wherein the host device is configured to:
determine, by the file system, that the plurality of data blocks stored at a plurality of first physical addresses in the nonvolatile memory device are to be moved to a plurality of second physical addresses in the nonvolatile memory device, and
issue, to the storage device, a synchronous move request including:
a move data descriptor including a plurality of first logical addresses included in the first file system metadata and mapped to the plurality of first physical addresses of the plurality of data blocks and a plurality of second logical addresses which are to be mapped to the plurality of second physical addresses of the plurality of data blocks, and
a metadata descriptor including a third logical address at which the second file system metadata is to be stored,
wherein the storage device is configured to perform, in response to the synchronous move request, a data move operation and a metadata update operation,
wherein the storage device is configured further to:
move, in the data move operation, the plurality of data blocks from the plurality of first physical addresses to the plurality of second physical addresses in the nonvolatile memory device based on the move data descriptor of the synchronous move request, and
write, in the metadata update operation, the second file system metadata in the nonvolatile memory device,
wherein the second file system metadata includes the plurality of second logical addresses mapped to the plurality of second physical addresses,
wherein the host device is configured further to perform a file system metadata update operation to update the first file system metadata with the second file system metadata.

2. The storage system of claim 1,
wherein the storage device performs the data move operation and the metadata update operation consecutively in response to the synchronous move request.

3. The storage system of claim 1,
wherein the plurality of second physical addresses are continuous, and
wherein the storage device is configured further to:
map the plurality of second physical addresses to the plurality of second logical addresses.

4. The storage system of claim 1,
wherein the storage device is configured further to perform the synchronous move request without transferring the plurality of data blocks mapped to the plurality of first physical addresses and the plurality of data blocks mapped to the plurality of second physical addresses between the storage device and the host device.

5. The storage system of claim 1,
wherein the plurality of data blocks mapped to the plurality of first physical addresses are scattered into a plurality of data groups that are stored in non-contiguous physical locations of the nonvolatile memory device, and
wherein the move data descriptor includes a plurality of data entries associated with the plurality of data groups, respectively.

6. The storage system of claim 5,
wherein each data entry of the plurality of data entries includes source information and destination information,
wherein the source information includes a logical address of each data group of the plurality of data groups before the data move operation is performed and a number of data blocks included in each data group of the plurality of data groups before the data move operation is performed, and
wherein the destination information includes a logical address of each data group of the plurality of data groups after the data move operation is performed and a number of data blocks included in each data group of the plurality of data groups after the data move operation is performed.

7. The storage system of claim 5,
wherein the move data descriptor further includes a group count indicating a number of the plurality of data entries.

8. The storage system of claim 1,
wherein the metadata descriptor includes a first field representing the second file system metadata, a second field representing the third logical address of the second file system metadata and a size of the second file system metadata.

9. The storage system of claim 1,
wherein, when the storage device completes the data move operation and the metadata update operation, the storage device is configured further to issue, to the host device, a first response indicating that the data move operation and the metadata update operation are successfully performed.

10. The storage system of claim 9,
wherein the host device is configured further to:
update, in response to the first response, the first file system metadata stored in the host device with the second file system metadata.

11. The storage system of claim 6,
wherein the storage device is configured further to:
after completing the data move operation and the metadata update operation, delete an address mapping between the logical address of each data group in the source information and a physical address corresponding to the logical address of each data group in the source information.

12. The storage system of claim 1,
wherein, when the storage device fails to complete the data move operation and the metadata update operation, the storage device is configured further to issue, to the host device, a second response indicating failure of the moving of the plurality of data blocks.

13. The storage system of claim 1,
wherein, when the storage device is powered off before completing the data move operation and the metadata update operation, the host device is configured to restore the plurality of data blocks mapped to the plurality of first physical addresses based on the first file system metadata stored in the host device.

14. The storage system of claim 1,
wherein the storage device is configured further to determine, prior to performing the data move operation and the metadata update operation, a validity of each of the move data descriptor and the metadata descriptor transferred from the host device.

15. The storage system of claim 14,
wherein the storage device is configured further to perform the data move operation and the metadata update operation in response to determining the move data descriptor and the metadata descriptor as valid, and
wherein the storage device is configured further to issue, to the host device, a third response indicating failure of the moving of the plurality of data blocks in response to determining at least one of the move data descriptor and the metadata descriptor as not valid.

16. A method of performing a data relocation driven by a host device on a storage device, the method comprising:
determining, by a file system of the host device, a relocation of a plurality of data blocks stored in a nonvolatile memory device of the storage device;
transferring, from the host device to the storage device, a synchronous move request including a move data descriptor indicating information on a storage location of the plurality of data blocks and a metadata descriptor indicating information on a change in a file system metadata according to the relocation;
performing, by the storage device, a data move operation to change the storage location of the plurality of data blocks stored in the nonvolatile memory device based on the move data descriptor; and
performing, by the storage device, a metadata update operation to write a new file system metadata in the nonvolatile memory device based on the metadata descriptor after the performing of the data move operation.

17. The method of claim 16,
wherein the performing of the data move operation and the performing of the metadata update operation are consecutively performed in response to the synchronous move request.

18. The method of claim 16, further comprising:
issuing, by the storage device, a response indicating success of the data relocation to the host device; and
updating a previous system metadata stored in the host device with the new file system metadata.

19. The method of claim 16, further comprising:
determining, by the storage device, a validity of the move data descriptor transferred from the host device and a validity of the metadata descriptor transferred from the host device,
wherein the performing of the data move operation and the performing of the metadata update operation are performed in response to the determining of the validity of each of the move data descriptor and the metadata descriptor as valid.

20. A method of performing a data relocation driven by a host device on a storage device, the method comprising:
determining, by a file system of the host device, a relocation of a plurality of data blocks of a file stored in a nonvolatile memory device of the storage device;
transferring, from the host device to the storage device, a synchronous move request including a move data descriptor indicating information on a storage location of the plurality of data blocks and a metadata descriptor indicating information on a change in a file system metadata according to the relocation;
performing, by the storage device, a data move operation to change the storage location of the plurality of data blocks stored in the nonvolatile memory device based on the move data descriptor;
performing, by the storage device, a metadata update operation to write a new file system metadata in the nonvolatile memory device based on the metadata descriptor after the performing of the data move operation;
transferring, from the storage device to the host device, a first response indicating success of the relocation to the host device, when the storage device completes the data move operation and the metadata update operation; and
updating, by the host device, a previous file system metadata stored in the host device with the new file system metadata, when the host device receives the first response indicating success of the relocation,
wherein the previous file system metadata includes a logical address storing a first pointer indicating where the file is stored before the synchronous move request is performed and the new file system metadata includes a logical address storing a second pointer indicating where the file is to be stored after the synchronous move request is performed, and
wherein the performing of the data move operation and the performing of the metadata update operation are consecutively performed in response to the synchronous move request.
